(19) United States
(12) Patent Application Publication
(10) Pub. No.: US 2025/0219924 A1
(43) Pub. Date: Jul. 3, 2025

(54) CALL TRACE AND TRACE FILE TRANSFER IN A CLOUD-BASED 5G COMMUNICATION NETWORK

(71) Applicant: DISH Wireless L.L.C., Englewood, CO (US)

(72) Inventors: Kenneth William Weber, JR., Littleton, CO (US); Muhammad Zaeem Afzal, Mckinney, TX (US); Mohammad Dawood Shahdad, Aurora, CO (US)

(21) Appl. No.: 18/397,925

(22) Filed: Dec. 27, 2023

(51) Int. Cl. H04L 43/10; H04W 24/08

(52) U.S. Cl. CPC H04L 43/10; H04W 24/08

(57) ABSTRACT

A method for performing a call trace in the cloud-based communication network includes receiving, using a call trace module, a region for a user equipment (UE) device and a subscriber number for the UE device, identifying, using the call trace module, a set of network functions associated with the region for the UE device from a plurality of network functions of the communication network, establishing, using the call trace module, a call trace for each network function in the set of network functions, collecting, using the call trace module, call trace data associated with the subscriber number for the UE device from one or more network functions in the set of network functions, storing, using the call trace module, the collected call trace data in a data storage device, and generating, using the call trace module, a report with at least the collected call trace data.

### FIELD

The present disclosure relates generally to wireless communication networks and, more particularly, systems and methods for performing a call trace in a cloud-based communication network.

### BACKGROUND

Wireless communication networks that transport digital data and telephone calls are becoming increasingly sophisticated. Currently, fifth generation (5G) communication networks, are being deployed around the world. These 5G networks use emerging technologies to support data and voice communications with millions, if not billions, of mobile phones, computers, and other devices. 5G technologies are capable of supplying much greater bandwidths than was previously available.

### SUMMARY

In accordance with an embodiment, a method for performing a call trace in a cloud-based communication network having a plurality of network functions, where each network function includes one or more pods, includes receiving, using a call trace module, a region for a user equipment (UE) device and a subscriber number for the UE device, identifying, using the call trace module, a set of the network functions associated with the region for the UE device from the plurality of network functions of the communication network, establishing, using the call trace module, a call trace for each network function in the set of network functions, collecting, using the call trace module, call trace data associated with the subscriber number for the UE device from one or more network functions in the set of network functions, storing, using the call trace module, the collected call trace data in a data storage device, and generating, using the call trace module, a report with at least the collected call trace data.

In accordance wither another embodiment, a system for performing a call trace in a cloud-based communication network having a plurality of network functions, where each network function includes one or more pods, includes a memory that stores one or more computer readable media that include instructions, and one or more processor devices that execute the instructions of the computer readable media to perform a process. The process includes receiving a region for a user equipment (UE) device and a subscriber number for the UE device, identifying a set of the network functions associated with the region for the UE device from the plurality of network functions of the communication network, establishing a call trace for each network function in the set of network functions, collecting call trace data associated with the subscriber number for the UE device from one or more network functions in the set of network functions, storing the collected call trace data, generating a report with at least the collect call trace data.

In accordance with another embodiment, a non-transitory, computer-readable medium storing instructions that, when executed by an electronic processor, perform a set of functions, the set of functions includes receiving, using a call trace module, a region for a user equipment (UE) device and a subscriber number for the UE device, identifying, using the call trace module, a set of the network functions associated with the region for the UE device from a plurality of network functions of a communication network, establishing, using the call trace module, a call trace for each network function in the set of network functions, collecting, using the call trace module, call trace data associated with the subscriber number for the UE device from one or more network functions in the set of network function, storing, using the call trace module, the collected call trace data in a data storage device, and generating, using the call trace module, a report with at least the collect call trace data.

### BRIEF DESCRIPTION OF THE DRAWINGS

The present disclosure will hereafter be described with reference to the accompanying drawings, wherein like reference numerals denote like elements.

FIG. 1 is a block diagram of an example wireless communication network in accordance with an embodiment;

FIG. 2A is a block diagram of a system for performing a call trace in a cloud-based communication network in accordance with an embodiment;

FIG. 2B is a block diagram of a system for performing a call trace in a cloud-based communication network in accordance with an embodiment;

FIG. 3 illustrates a method for performing a call trace in a cloud-based communication network in accordance with an embodiment; and

FIG. 4 is a block diagram of an example computer system in accordance with an embodiment.

### DETAILED DESCRIPTION

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computer device or can be distributed among different computing devices connected by one or more networks or other suitable communication links.

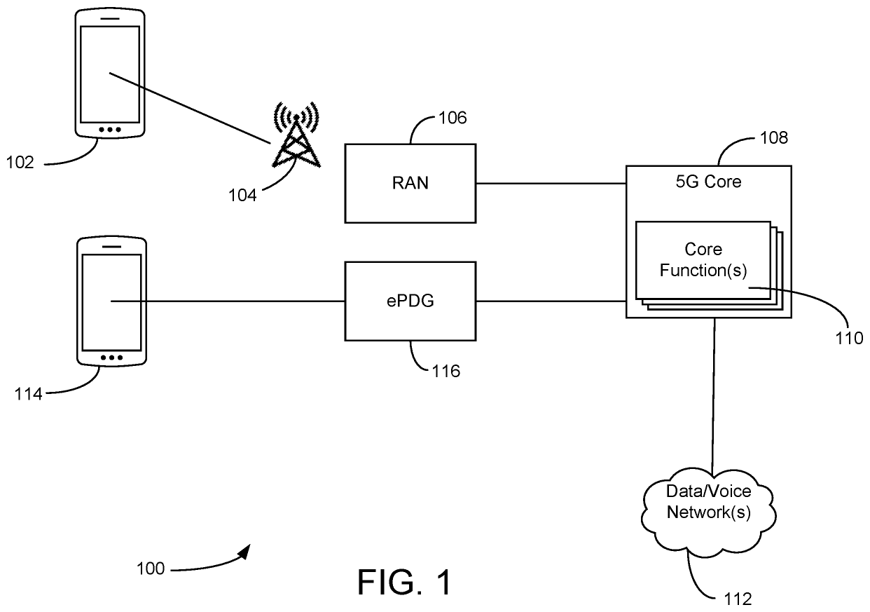

FIG. 1 is a schematic block diagram of an example wireless communication network in accordance with an embodiment. The wireless communication network 100 can include a user equipment (UE) device 102, UE device 114, a radio access network (RAN) 106, an evolved packet data gateway (ePDG) 116, and a 5G core 108. In some embodiments, the RAN 106 and 5G core 108 can enable the UE device 102 to, for example, communicate with other UE devices and to communicate with one or more external data networks (DNS) 112 (e.g., the Internet or a private corporate network) using the RAN 106 and 5G core 108. For example, if the external data network 112 is the Internet, the RAN 106 and 5G core 108 can allow the UE device 102 to send and receive data via the Internet. In some embodiments, the ePDG 116 and 5G core 108 can enable the UE device 114 to, for example, communicate with other UE devices and to communicate with one or more external data networks (DNs) 112 using the ePDG 116 and 5G core 108. The ePDG 116 may be utilized if a UE 114 is communicating via a WiFi connection and WiFi access network. While FIG. 1 illustrates various components of communication network 100, other embodiments of communication network 100 can vary the arrangement, communication paths, and specific components of communication network 100. In some embodiments, the wireless communication network 100 can include fewer, additional, or different components in different configurations than illustrated in FIG. 1. For example, in some embodiments, the wireless communication network 100 may include additional or different UE devices 102, 114.

The wireless communication network 100 may be used to facilitate multiple types of communication sessions, such as, for example, voice calls, video calls, messaging, data transmission, and/or other types of communications. The wireless communication network 100 may represent a portion of a wireless network built around 5G (fifth generation) standards promulgated by standards setting organizations under the umbrella of the Third Generation Partnership Project (3GPP). Accordingly, in some configurations, the wireless communication network 100 may be a 5G network, such as, for example, a 5G cellular network. Such 5G networks, including the wireless communication network 100, may comply with industry standards, such as, for example, the Open Radio Access Network (Open RAN or O-RAN) standard that describes interactions between the network and user equipment (e.g., mobile phones and the like). The O-RAN model follows a virtualized model for a 5G wireless architecture in which 5G base stations (gNBs) are implemented using separate centralized units (CUs), distributed units (DUs), and radio units (RUS). In some configurations, O-RAN CUs and DUs may be implemented using software modules executed by distributed (e.g., cloud) computing hardware.

In some configurations, the wireless communication network 100 may be a standalone (SA) network (e.g., a 5G SA network) that utilizes 5G cells for both signaling and information transfer via a 5G packet core architecture. In other configurations, the wireless communication network 100 may be a non-standalone (NSA) network that depends on another network, such as, for example, a control plane of a fourth generation (4G) long-term evolution (LTE) network.

As mentioned, in some embodiments, the UE device 102, 114 can transmit data from one or more applications on the UE device 102, 114 to an external data network (DN) 112, for example, the Internet, via the communication network 100. While FIG. 1 illustrates two UE devices 102, 114, in some embodiments, it should be understood that the communication network 100 can support more than two UE devices 102, 114. UE devices 102 and 114 can be various forms of wireless devices that are capable of communication according to the radio access technology (RAT) of the wireless communication network 100 (e.g., a 5G new radio (NR) network). For example, in some embodiments, the UE device 102, 114 can be a smartphone, a wireless modem, a cellular phone, a laptop computer, a wireless access point (AP), etc.

After the UE device 102 or the UE device 114 has established a connection or session with the RAN 106 or the ePDG 116, respectively, the communication network 100 can provide data (e.g., data packets) to the UE device 102, 114 and can receive data from the UE device 102, 114. In some embodiments, the data can include, for example, voice data for a phone call, data provided by a web server to the UE device 102, 114, data provided by the UE device 102, 114 to a Web server, or other types of data commonly exchanged on wireless communication networks. For example, after the UE device 102 or the UE device 114 has established a connection or session with the RAN 106 or the ePDG 116, respectively, a user of the UE device 102, 114 may select to stream a video on an application of the UE device 102, 114 via the Internet (e.g. data network 112). The video stream can be provided to the UE device 102, 114 on data packets.

The UE device 102 can communicate with the RAN 106 in various ways, such as, for example, via a radio transceiver 104, which may also be referred to as a radio unit (RU) in the O-RAN architecture. The RAN 106 may be or include a disaggregated RAN (referred to as an Open RAN or O-RAN) which can include hierarchy (e.g., tree structure) of RAN functions. In such examples, the RAN 106 may include on or more CUs and one or more DUs. For example, each of multiple CUs may be coupled with multiple DU, and each DU may be coupled with multiple RUs (e.g., the radio transceiver 104). As such, each UE device 102 can communicate with backhaul network infrastructure (e.g., a 5G Core 108) according to an assigned communication path through a particular RU, DU, and CU. An RU (e.g., the radio transceiver 104) in combination with a DU and CU may be referred to as a gNodeB (gNB) in the O-RAN architecture. Such as gNB may be a 3GPP 5G next generation base station that supports communications with the with the UE device 102. In other embodiments, a UE device 114 may communicate with an ePDG 116 via a WiFi connection and WIFi access network (e.g., a WiFi router). In one example, if the UE 114 is not in coverage of a cell tower associated with a RAN (e.g., RAN 106), the UE device 114 may connect to a WiFi router which can communicate with the ePDG 116 which is configured to connect with the 5G core 108. Accordingly, the ePDG 116 may include various access and management network functions that enable the ePDG 116 to establish a connection with the 5G core 108.

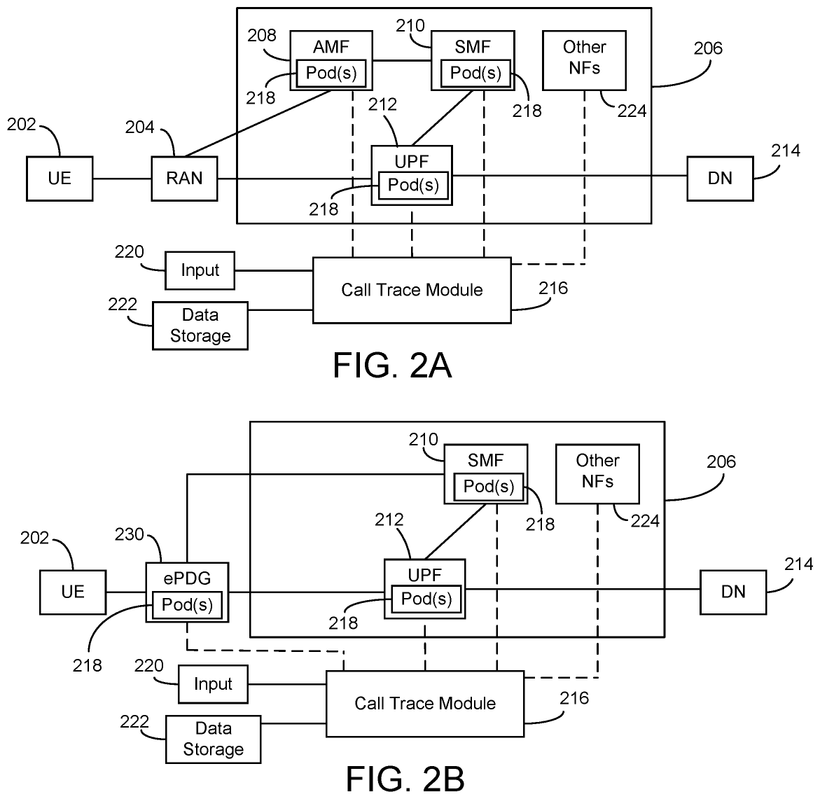

The 5G Core 108 may include one or more core functions 110. Each core function 110 can be a network function (NF) that provides a utility or service specific to the 5G core 108, for example, core functions of the communication network 100. In some embodiments, for example, different NFs may provide different utility to the communication network 100. In some embodiments, the 5G core 108 including the core functions 110 can reside on a cloud computing platform. For example, in some embodiments, the communication network (e.g., communication network 100), or portion thereof, in which the 5G core 108 is implemented may be disaggregated, such that, for example, NFs may be developed or operated by multiple vendors or operators. In some embodiments, an NF may be virtualized. An NF may be virtualized by implementing the NF in a cloud-native architecture. Accordingly, in some embodiments, an NF may be a cloud-native NF (CNF). A CNF may refer to a service (or utility) that performs network duties in software (e.g., as opposed to purpose-built hardware). Each core function (i.e., a network function (NF)) 110 can include multiple pods (e.g., pods 218 shown in FIGS. 2A and 2B). A “pod” refers to a software subcomponent of the network function. In some embodiments, multiple pods can be used to perform the function of the network function. In addition, in some embodiments, within a network function, multiple instantiations of the same pod may be present.

Examples of various core functions 110 can include a Network Slice Selection Function (NSSF), a Network Exposure Function (NEF), a Network Repository Function (NRF), a policy control function (PCF), a Unified Data Management (UDM) function, an Authentication Server Function (AUSF), an Access and Mobility Management Function (AMF), a Session Management Function (SMF), and a User Plane Function (UPF). The NSSF can provide tailor made logical networks on the physical network, for example, the NSSF can be used by the AMF to assist with the selection of a network slice that will serve a particular UE device. The NEF can expose services and resources over application programming interfaces (APIs) within and outside the 5G core. The NRF can enable 5G network functions (NFs) to register and discover each other via a standards-based application programming interface (API). The PCF can apply session policies for a UE device, or other devices, when connecting over, for example, 5G. The UDM can manage network user data in a single, centralized element and can allow for generation of authentication vectors, user identification handling, NF registration management, and retrieval of UE device individual subscription data for slice selection. The AUSF can allow the AMF to authenticate the UE and access services of the 5G core 108. The AMF can perform operations like mobility management, registration management, connection management, UE-based authentication, etc. The SMF can interact with the decoupled data plane, can perform internet protocol (IP) address allocation and management for UE devices (e.g., UE device 102, 114), user plane selection, and packet routing in conjunction with the UPF, etc. The UPF can perform user plane operations, such as maintaining protocol data unit (PDU) sessions, packet routing and forwarding, inspection policy enforcement for the user plane, Quality of Service (QoS) handling, providing data access to the UE 102, 114, etc. A PDU session can provide connectivity between applications on the UE device 102, 114 and the DN 112 (e.g., the Internet). The SMF can also be responsible for creating, updating, and removing PDU sessions, selecting particular UPFs on which to anchor PDU sessions when new UE devices 102, 114 appear on the communication network, and managing session context with the UPF. Together with the UPF, the SMF can maintain a record of PDU session state by means of a PDU Session ID.

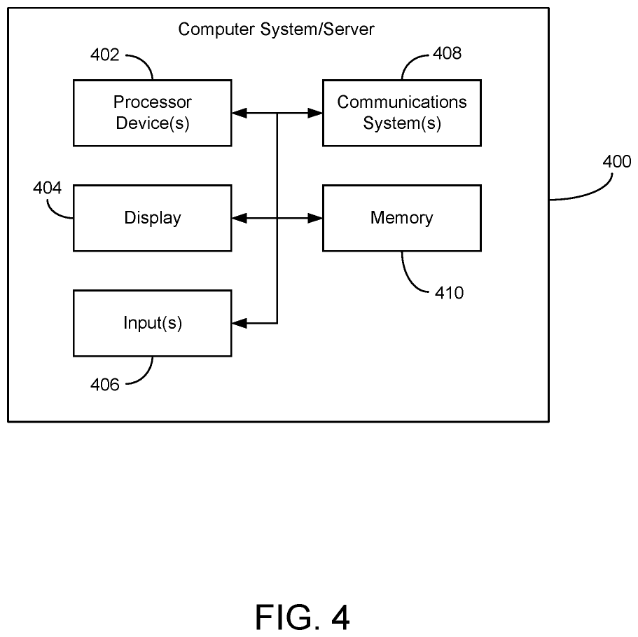

In some embodiments, the RAN 106, ePDG 116, and the 5G core 108 (including core functions 110) may be implemented on a computer system (e.g., computer system 400 discussed below with respect to FIG. 4) such as a server or the functionality of the RAN 106, ePDG 116, the 5G core 108 and core functions 110 may be distributed among multiple servers or devices (e.g., as part of a cloud service or cloud-computing environment). In some embodiments, the 5G core 108 can be physically distributed across data centers or located at a central national data center (NDC) (e.g., the 5G core can logically reside as part of an NDC). Within an NDC, multiple regional data centers (RDCs) can be logically present. In some embodiments, each of such one or more regional data centers may execute core functions 110 for a different geographic region or a group of RAN components.

On a communication network (e.g., a cellular network) such as communication network 100, it may be necessary to perform “call tracing” or a “call trace.” Due to the complexity of cellular networks, if end users are having difficulty making or receiving phone calls, an investigation may need to be performed into the issue to determine if a fault lies within the handling of calls within the cellular network core 108. There are many places within the core 108 where a call could be dropped or negatively affected. Call tracing allows communications (e.g., signaling messages) between cellular network core components (e.g., the network functions) to be gathered, output, and analyzed. Within a 5G NR cellular core, call tracing can involve collecting communications between network functions that are part of, for example, a call flow. As mentioned above, network functions (e.g., core functions 110) may be virtualized and implemented on a cloud computing platform. In addition, within the core 108 of the communication network 100, a particular network function (or component of a network function) may be instantiated many times over. Accordingly, it can be difficult, technically detailed, and time consuming for a network administrator to manually locate, monitor and test the call flow for a particular UE on a cloud-based communication network.

The present disclosure describes systems and methods for performing a call trace in a cloud computing system. In some embodiments, a call trace module may be provided that is configured to perform an automated call trace for a user equipment device. For example, in some embodiments, the call trace module can be configured to receive inputs related to a UE device for which a call trace is to be performed, for example, a region in which the UE device is physically located and a subscriber number (e.g., a phone number) of the UE device. Based on the received inputs, the call trace module can automatically identify network functions associated with the region of the UE device, establish call traces for the identified network functions (and/or for pods in the identified network functions), and collect (or fetch) call trace data (e.g., signaling messages exchanged between the identified network functions) associated with the subscriber number from the identified network functions. In some embodiments, the call trace module can also store the collected call trace data in a data storage device (e.g., memory) and generate a report that can include the collected call trace data for the UE device. An administrator can view the report including the call trace data to, for example, diagnose whether a problem is present in how calls are being handled by the core of the communication network. The disclosed systems and methods can advantageously reduce the time required to establish (or enable) a call trace and collect data for the call trace. For example, in some embodiments, the systems and methods described herein can reduce the time to set up a call trace and collect call trace data from hours to minutes.

FIG. 2A is a block diagram of a system for performing a call trace in a cloud-based communication network in accordance with an embodiment. In the embodiment illustrated in FIG. 2A, a core 206 (e.g., 5G core 108 shown in FIG. 1), including a plurality of network functions, is illustrated for providing communication between a UE device 202 and a data network 214. The UE device 202 can communicate with a RAN 204 wirelessly, for example, via a radio transceiver (e.g., radio transceiver 104 shown in FIG. 1). Core 206 can include an AMF 208, an SMF 210, an UPF 212. In some embodiments, the core 206 may include a UPF for voice calls (UPF V) and a UPF for data (UPF D). In FIG. 2A, the example core 206 is simplified to show some key components, however, implementations can involve additional components. While one instance of each example network function is shown in the embodiment illustrated in FIG. 2A, it should be understood that, in some embodiments the core 206 can include multiple instantiations of each network function. While three exemplary network functions are illustrated as part of core 206, as described above various other network functions can additionally or alternatively be present, which is represented in FIG. 2A with the box labeled Other NFs 224. Examples of other NFs for a core are described above with respect to FIG. 1.

As mentioned above, each network function (AMF 208, SMF, 210, and UPF 212) can each include one or more pods 218. The pod(s) 218 in each network function 208, 210, 212 can be used to perform the function of the particular network function 208, 210, 212. Within each network function 208, 210, 212, multiple instantiations of the same pod may be present. The network functions 208, 210, 212 may communicate (illustrated with solid lines in FIG. 2A), for example, using signaling messages, with each other, RAN 204, and/or DN 214 to, for example, execute and complete a call. For example, the AMF 208 and the RAN 204 can communicate messages with one another over an interface (e.g., an N2 interface), the RAN 204 and the UPF 212 can communicate messages and data with one another over an interface (e.g., an N3 interface), the SMF 210 and the UPF 212 can communicate messages with one another over an interface (e.g., an N4 interface), the UPF 212 can send and receive signals and data with the data network (DN) 214 over an Internet interface (e.g., an N6 interface), and the AMF 208 and the SMF 210 can communicate signals and messages with one another over an interface (e.g., an N11 interface).

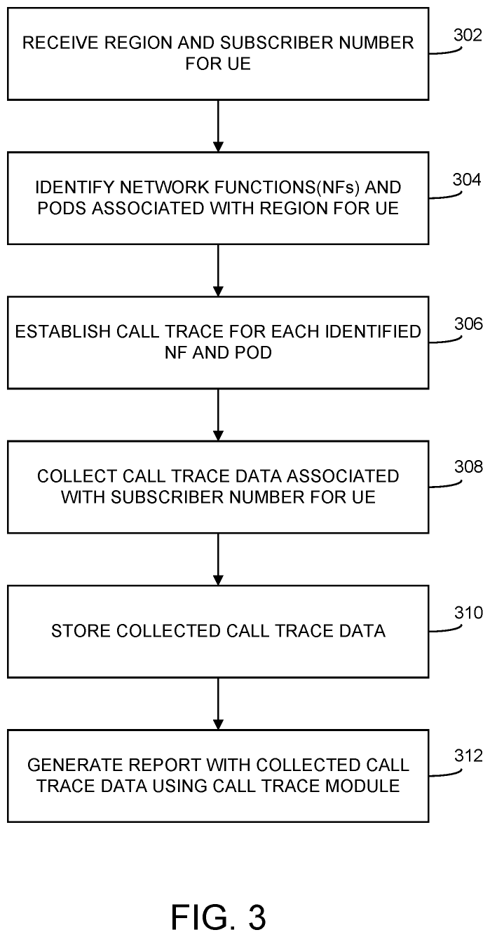

The system illustrated in FIG. 2A may also include a call trace module 216 configured for performing a call trace. In some embodiments, the call trace module 216 may be implemented on a computer system (e.g., computer system 400 discussed below with respect to FIG. 4) such as a server. In some embodiments, the call trace module 216 may be implemented at a national data center (NDC) or a regional data center (RDC). The call trace module 216 can be configured to receive inputs 220. For example, in some embodiments, the inputs may be provided by an operator or network administrator using a user interface (e.g., inputs 406 shown in FIG. 4) configured to allow a user to interact with the system. If an administrator is tasked with investigating a problem for a UE device 202 (e.g., a dropped call), the administrator may provide inputs 220 related to the UE device 202 to the call trace module 216. In some embodiments, the input 220 can include a region of a UE device (i.e., the region in which the UE device is physically located) and a subscriber number (e.g., a phone number) of the UE device. Based on the region of the UE device and the subscriber number, the call trace module 216 can be configured to perform a an automated call trace for the UE device. In some embodiments, the call trace module 216 can identity the network functions (e.g. AMF 208, SMF 210, UPF 212) associated with the region of the UE device 202. The call trace module 216 can then establish or enable a call trace with the identified network functions associated with the region of UE device 202. The communication between the call trace module 216 and the identified AMF 208, SMF 210, and UPF 212 for the region of the UE device 202 is illustrated in FIG. 2A with dotted lines. In some embodiments, the call trace module 216 may establish a call trace with the pods 218 in each of the identified network functions. Once the call traces with the identified network functions for the region of the UE device have been established, the call trace module 216 can collect or transfer call trace data associated with the subscriber number of the UE device 202. In some embodiments, the call trace data can include signaling messages exchanged between the identified network functions of core 206. Accordingly, the call trace module 216 can collect all the signaling messages that are associated with the subscriber number of the UE device for communication traffic between the identified network functions. The call trace module can then store the call trace data, for example, in data storage 222 (e.g., memory 410 shown in FIG. 4). In some embodiments, the call trace module 216 can also be configured to generate a report which may be displayed on a display (e.g., on display 404 shown in FIG. 4) for the administrator to view. Methods that may be executed by the call trace module 216 to perform a call trace are discussed further below with respect to FIG. 3.

As discussed above with respect to FIG. 1, in some embodiments, a UE device may communicate with an ePDG via a WiFI connection and a WiFi access network. FIG. 2B is a block diagram of a system for performing a call trace in a cloud-based communication network in accordance with an embodiment. In the embodiment illustrated in FIG. 2B, the UE device 202 communicates with an ePDG 230 which can connect with a core 206. The core 206 (e.g., 5G core 108 shown in FIG. 1), including a plurality of network functions, is illustrated for providing communication between a UE device 202 and a data network 214. The UE device 202 can communicate with ePDG via a WiFi connection and WiFI access network. Core 206 can include an SMF 210, and an UPF 212. In some embodiments, the core 206 may include a UPF for voice calls (UPF V) and a UPF for data (UPF D). The ePDG 230 can be configured to include various access and management network functions that enable the ePDG 230 to establish a connection with the core 206. In FIG. 2B, the example core 206 is simplified to show some key components, however, implementations can involve additional components. While one instance of each example network function is shown in the embodiment illustrated in FIG. 2B, it should be understood that, in some embodiments the core 206 can include multiple instantiations of each network function. While three exemplary network functions are illustrated as part of core 206, as described above various other network functions can additionally or alternatively be present, which is represented in FIG. 2B with the box labeled other NFs 224. Examples of other NFs for a core are described above with respect to FIG. 1.

As mentioned above, each network function (SMF, 210, UPF 212, and the network functions of ePDG 230) can each include one or more pods 218. The pod(s) 218 in each network function can be used to perform the function of the particular network functions. Within each network function, multiple instantiations of the same pod may be present. The network functions may communicate (illustrated with solid lines in FIG. 2B), for example, using signaling messages, with each other, ePDG 204, and/or DN 214 to, for example, execute and complete a call. For example, the ePDG 230 and the UPF 212 can communicate messages and data with one another over an interface, the ePDG 230 and the SMF 210 can communicate message with one another over an interface, the SMF 210 and the UPF 212 can communicate messages with one another over an interface, and the UPF 212 can send and receive signals and data with the data network (DN) 214 over an Internet interface.

The system illustrated in FIG. 2B may also include a call trace module 216 configured for performing a call trace. In some embodiments, the call trace module 216 may be implemented on a computer system (e.g., computer system 400 discussed below with respect to FIG. 4) such as a server. In some embodiments, the call trace module 216 may be implemented at a national data center (NDC) or a regional data center (RDC). The call trace module 216 can be configured to receive inputs 220. For example, in some embodiments, the inputs may be provided by an operator or network administrator using a user interface (e.g., inputs 406 shown in FIG. 4) configured to allow a user to interact with the system. If an administrator is tasked with investigating a problem for a UE device 202 (e.g., a dropped call), the administrator may provide inputs 220 related to the UE device 202 to the call trace module 216. In some embodiments, the input 220 can include a region of a UE device (i.e., the region in which the UE device is physically located) and a subscriber number (e.g., a phone number) of the UE device. Based on the region of the UE device and the subscriber number, the call trace module 216 can be configured to perform a an automated call trace for the UE device. In some embodiments, the call trace module 216 can identity the network functions (e.g. SMF 210, UPF 212, and the network functions of ePDG 230) associated with the region of the UE device 202. The call trace module 216 can then establish or enable a call trace with the identified network functions associated with the region of UE device 202. The communication between the call trace module 216 and the identified SMF 210, UPF 212, and the network functions of ePDG 230 for the region of the UE device 202 is illustrated in FIG. 2B with dotted lines. In some embodiments, the call trace module 216 may establish a call trace with the pods 218 in each of the identified network functions. Once the call traces with the identified network functions for the region of the UE device have been established, the call trace module 216 can collect or transfer call trace data associated with the subscriber number of the UE device 202. In some embodiments, the call trace data can include signaling messages exchanged between the identified network functions of core 206. Accordingly, the call trace module 216 can collect all the signaling messages that are associated with the subscriber number of the UE device for communication traffic between the identified network functions. The call trace module can then store the call trace data, for example, in data storage 222 (e.g., memory 410 shown in FIG. 4). In some embodiments, the call trace module 216 can also be configured to generate a report which may be displayed on a display (e.g., on display 404 shown in FIG. 4) for the administrator to view. Methods that may be executed by the call trace module 216 to perform a call trace are discussed further below with respect to FIG. 3.

FIG. 3 illustrates a method for performing a call trace in a cloud-based communication network in accordance with an embodiment. The process illustrated in FIG. 3 is described as being carried out by the systems illustrated in FIGS. 1, 2A and 2B. Although the blocks of the process are illustrated in a particular order, in some embodiments, one or more blocks may be executed in a different order than illustrated in FIG. 3, or may be bypassed.

At block 302, a region for a UE device 202 and a subscriber number for the UE device 202 may be received by a call trace module 216. The UE device 202 may be a device for which a network administrator is performing an investigation regarding a problem, for example, a dropped call reported by an end user of the UE device 202. The region and subscriber number may be input to the call trace module 216 by the administrator using, for example, an input 220 such as a user interface. In some embodiments, the region for the UE device 202 may be the region in which the UE device 202 is physically located (e.g., a city or other geographic area). In some embodiments, the subscriber number for the UD device 202 can be a phone number.

At block 304, network functions of a core 206 may be identified that are associated with the region of the UE device 202 using the call trace module 216. In some embodiments, a communication system may include a plurality of network functions. Based on the region of the UE device 203, a set of network functions from the plurality of network functions of the communication network can be identified by the call trace module 216. In other words, the call trace module 216 is configured to identify all the relevant network functions for the region of the UE device 202. Accordingly, the region of the UE device 202 may be used to point to particular instances of network functions. In some embodiments, the identified network functions can include one or more of an AMF 208, an SMF 210, an UPF 212, and network functions of an ePDG 230. Each identified network function may include one or more pods 218.

At block 306, a call trace may be established or enabled using the call trace module 216 for each network function identified at block 304 and in some embodiments, for each pod of each identified network function. In some embodiments, the call trace module 216 may set up a call trace at each identified network function (and/or for each pod of each network function) by, for example, logging in to a network function and enabling a call trace. The call trace may be configured to capture communication traffic, for example, signaling messages between the identified network functions. At block 308, call trace data (e.g., signaling messages) may be collected using the call trace module 216 based on the subscriber number of the UE device. Accordingly, the subscriber number (e.g., a phone number) for the UE device 202 can be used to pull out call trace data for the specific UE device 202 and calls associated with the UE device 202. At block 310, the collected call trace data may be stored, for example, in data storage 222. At block 312, a report may be generated sing the call trace module 216 that include at least the collected call trace data for the UE device 202. In some embodiments, the report with the call trace data may be displayed (e.g., on display 404 shown in FIG. 4) for the administrator to view. For example, the administrator may view the collected call trace data in the report to try to identify where the issue is that has caused the problem (e.g., a dropped call).

As mentioned above, various components of the communication network 100 and the disclosed systems in FIGS. 2A and 2B may be implemented on a computer system (e.g., a server). FIG. 4 is a block diagram of an example computer system in accordance with an embodiment. The computer system 400 (e.g., a server) may include one or more processor devices 402, a display 404, one or more inputs 406, one or more communications systems 408, and memory 410. In some embodiments, processor device(s) 402 can be any suitable hardware processor or combination of processors, such as a CPU, a GPU, an ASIC, an EPGA, etc. The processor device(s) 402 may include one or more processors, processor cores, processing elements, processor clusters, or other electronic processing units. Accordingly, a processing function described as being performed by the processor device(s) 402 may include multiple processors, processor cores processing elements, processing clusters, etc. (of processor device(s) 402) performing aspects or portions (subfunctions) of the processing function to complete the processing function. The one or more electronic processing units of the processor device(s) may include one or more microprocessors, application-specific integrated circuits (ASICs), or other suitable electronic device for processing data. At least in some examples, the one or more electronics processing units of the processor device(s) 402 can be co-located physically (e.g., in the same facility, building, room, rack, or computer housing) as part of the computer system 400.

In some embodiments, display 504 can include any suitable display devices, such as a computer monitor, a touchscreen, a television, etc. In some embodiments, display 404 can be omitted. In some embodiments, inputs 406 can include any suitable input devices and/or sensors that can be used to receive user input, such as a keyboard, a mouse, a touchscreen, a microphone, etc. In some embodiments, inputs 406 can be omitted.

In some embodiments, communications system(s) 408 can include any suitable hardware, firmware, and/or software for communicating information over any suitable communication network (e.g., communication network 100 shown in FIG. 1). For example, communication system(s) 408 can include one or more transceivers, one or more communication chips and/or chip sets, etc. In a more particular example, communications system(s) 408 can include hardware, firmware and/or software that can be used to establish a WiFi connection, a Bluetooth connection, a cellular connection, an Ethernet connection, etc.

In some embodiments, memory 410 can include any suitable storage device or devices (e.g., one or more non-transitory computer readable media) that can be used to store instructions, values, etc., that can be used, for example, by processor 402 to present content using display 404, to communicate with a UE 102 (shown in FIG. 1), to communicate with external data network (e.g., the Internet), to communicate with other computer systems (e.g., servers), etc. Memory 410 can include any suitable volatile memory, non-volatile memory, storage, or any suitable combination thereof. For example, memory 410 can include RAM, ROM, EEPROM, one or more flash drives, one or more hard disks, one or more solid state drives, one or more optical drives, etc. The memory 410 may store data and/or instructions for use and execution by the computer system 400 (e.g., by the processor device(s) 402) to implement the functionality of, for example, the RAN 104, ePDG 116, and the 5G core 108, shown in FIG. 1 and the call trace module 216 shown in FIGS. 2A and 2B. In some embodiments, the functionality described herein as being performed by the computer system 400 may be distributed among multiple computer system, servers, or devices (e.g., as part of a cloud service or cloud-computing environment).

In some examples, aspects of the technology, including computerized implementations of methods according to the technology, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, examples of the technology can be implemented as a set of instructions, tangibly embodied on a non-transitory computer-readable media, such that a processor device can implement the instructions based upon reading the instructions from the computer-readable media. Some examples of the technology can include (or utilize) a control device such as an automation device, a special purpose or general-purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.

Certain operations of methods according to the technology, or of systems executing those methods, can be represented schematically in the FIGs. or otherwise discussed herein. Unless otherwise specified or limited, representation in the FIGs. of particular operations in particular spatial order can not necessarily require those operations to be executed in a particular sequence corresponding to the particular spatial order. Correspondingly, certain operations represented in the FIGs., or otherwise disclosed herein, can be executed in different orders than are expressly illustrated or described, as appropriate for particular examples of the technology. Further, in some examples, certain operations can be executed in parallel, including by dedicated parallel processing devices, or separate computing devices configured to interoperate as part of a large system.

The present technology has been described in terms of one or more preferred embodiments, and it should be appreciated that many equivalents, alternatives, variations, and modifications, aside from those expressly stated, are possible and within the scope of the invention.

1. A method for performing a call trace in a cloud-based communication network comprising a plurality of network functions, where each network function includes one or more pods, the method comprising:
receiving, using a call trace module, a region for a user equipment (UE) device and a subscriber number for the UE device;
identifying, using the call trace module, a set of the network functions associated with the region for the UE device from the plurality of network functions of the communication network;
establishing, using the call trace module, a call trace for each network function in the set of network functions;
collecting, using the call trace module, call trace data associated with the subscriber number for the UE device from one or more network functions in the set of network functions;
storing, using the call trace module, the collected call trace data in a data storage device; and
generating, using the call trace module, a report with at least the collected call trace data.

2. The method according to claim 1, wherein establishing, using the call trace module, a call trace for each network function of the set of network functions further comprises establishing a call trace for at least one pod of each network function in the set of network functions.

3. The method according to claim 1, wherein collecting, using the call trace module, call trace data associated with the subscriber number for the UE device from one or more network functions further comprises collecting call trace data associated with the subscriber number for the UE device from at least one pod in the one or more network functions.

4. The method according to claim 1, wherein the subscriber number is a phone number.

5. The method according to claim 1, wherein the identified set of network functions associated with the region for the UE device includes one or more of an access and mobility management function (AMF), a session management function (SMF, a user plane function (UPF), and an evolved packet data gateway (ePDG).

6. The method according to claim 1, wherein the call trace data comprises signaling messages.

7. The method according to claim 1, wherein the region for a user equipment (UE) device is a region in which the UE device is physically located.

8. A system for performing a call trace in a cloud-based communication network comprising a plurality of network functions, where each network function includes one or more pods, the system comprising:
a memory that stores one or more computer readable media that include instructions; and
one or more processor devices that execute the instructions of the computer readable media to perform a process comprising:
receiving a region for a user equipment (UE) device and a subscriber number for the UE device;
identifying a set of the network functions associated with the region for the UE device from the plurality of network functions of the communication network;
establishing a call trace for each network function in the set of network functions;
collecting call trace data associated with the subscriber number for the UE device from one or more network functions in the set of network functions;
storing the collected call trace data; and
generating a report with at least the collect call trace data.

9. The system according to claim 8, wherein establishing a call trace for each network function of the set of network functions further comprises establishing a call trace for at least one pod of each network function in the set of network functions.

10. The system according to claim 8, wherein collecting call trace data associated with the subscriber number for the UE device from one or more network functions further comprises collecting call trace data associated with the subscriber number for the UE device from at least one pod in the one or more network functions.

11. The system according to claim 8, wherein the identified set of network functions associated with the region for the UE device includes one or more of an access and mobility management function (AMF), a session management function (SMF, a user plane function (UPF), and an evolved packet data gateway (ePDG).

12. The system according to claim 8, wherein the call trace data comprises signaling messages.

13. The system according to claim 8, wherein the region for a user equipment (UE) device is a region in which the UE device is physically located.

14. A non-transitory, computer-readable medium storing instructions that, when executed by an electronic processor, perform a set of functions, the set of functions comprising:
receiving, using a call trace module, a region for a user equipment (UE) device and a subscriber number for the UE device;
identifying, using the call trace module, a set of the network functions associated with the region for the UE device from a plurality of network functions of a communication network;
establishing, using the call trace module, a call trace for each network function in the set of network functions;
collecting, using the call trace module, call trace data associated with the subscriber number for the UE device from one or more network functions in the set of network functions;
storing, using the call trace module, the collected call trace data in a data storage device; and
generating, using the call trace module, a report with at least the collect call trace data.

15. The non-transitory computer-readable medium according to claim 14, wherein each network function of the plurality of network functions of the communication network includes one or more pods, and wherein establishing, using the call trace module, a call trace for each network function of the set of network functions further comprises establishing a call trace for at least one pod of each network function in the set of network functions.

16. The non-transitory computer-readable medium according to claim 14, wherein each network function of the plurality of network functions of the communication network includes one or more pods, and wherein collecting, using the call trace module, call trace data associated with the subscriber number for the UE device from one or more network functions further comprises collecting call trace data associated with the subscriber number for the UE device from at least one pod in the one or more network functions.

17. The non-transitory computer-readable medium according to claim 14, wherein the subscriber number is a phone number.

18. The non-transitory computer-readable medium according to claim 14, wherein the identified set of network functions associated with the region for the UE device includes one or more of an access and mobility management function (AMF), a session management function (SMF, a user plane function (UPF), and an evolved packet data gateway (ePDG).

19. The non-transitory computer-readable medium according to claim 14, wherein the call trace data comprises signaling messages.

20. The non-transitory computer-readable medium according to claim 14, wherein the region for a user equipment (UE) device is a region in which the UE device is physically located.
